(19) United States
(12) Patent Application Publication
(10) Pub. No.: US 2024/0157974 A1
(43) Pub. Date: May 16, 2024

(54) SIMULATION DEVICE FOR OUTPUTTING IMAGE DATA FROM A VIRTUAL ENVIRONMENT OF A VEHICLE TO A CONTROL UNIT, TEST SETUP HAVING SUCH A SIMULATION DEVICE, AND METHOD FOR OUTPUTTING IMAGE DATA FROM A VIRTUAL ENVIRONMENT OF A VEHICLE TO A CONTROL UNIT

(71) Applicant: dSPACE GmbH, Paderborn (DE)

(72) Inventors: Philipp MEYER, Paderborn (DE); Matthias GEHRKE, Paderborn (DE); Tobias SCHUMACHER, Paderborn (DE); Daniel TIGGES, Paderborn (DE); Uwe WICZONKE, Paderborn (DE)

(73) Assignee: dSPACE GmbH, Paderborn (DE)

(21) Appl. No.: 18/127,993

(22) Filed: Mar. 29, 2023

(30) Foreign Application Priority Data
Nov. 11, 2022 (DE) 10 2022 129 916.3

(51) Int. Cl. B60W 60/00; G05B 17/02; H04L 67/12

(52) U.S. Cl. CPC B60W 60/0016; G05B 17/02; H04L 67/12; B60W 2556/00

(57) ABSTRACT

A simulation device and a method for outputting image data from a virtual environment of a vehicle to a control unit is proposed, which are designed to perform at least one vehicle function dependent on the image data. An environment simulator is configured to simulate the environment of the vehicle, and transmits data about the environment to a sensor simulator, which is configured to simulate at least one sensor of the vehicle dependent on the data about the environment for detecting the environment and to output the image data dependent on its simulation. The environment simulator is designed to determine the data about the environment at simulation clock times and to transmit these to the sensor simulator dependent on the simulation clock times, and wherein the sensor simulator is configured to output the image data at sensor clock times.

This nonprovisional application claims priority under 35 U.S.C. § 119(a) to German Patent Application No. 10 2022 129 916.3, which was filed in Germany on Nov. 11, 2022, and which is herein incorporated by reference.

### BACKGROUND OF THE INVENTION

### Field of the Invention

The application relates to a simulation device for outputting image data from a virtual environment of a vehicle to a control unit, a test setup having such a simulation device and a method for outputting image data from a virtual environment of a vehicle to a control unit.

### Description of the Background Art

The publication D. Gruyer et al.: Development of Full Speed Range ACC with SiVIC, a virtual platform for ADAS Prototyping, Test and Evaluation, 2013 IEEE Intelligent Vehicles Symposium, Jun. 23-26, 2013, Gold Coast, Australia discloses that the so-called SiVIC platform provides a simulation of sensor data and virtual road environment data with realistic dynamic models of mobile units such as vehicles, realistic sensors and other sensors. This allows for a vehicle function to be simulated directly under realistic conditions. The publication Van Hoa Nguyen et al.: On Conceptual Structuration and Coupling Methods of Co-Simulation Frameworks in Cyber-Physical Energy System Validation, Energies, 2017, 10, 1977 discloses a so-called co-simulation as an emerging method for cyber-physical energy systems and their assessment and validation. The combined combination of simulation devices in different areas into a joint experiment is intended to enable a holistic view of such a cyber-physical energy system on a system level. In this case, a structuring of the co-simulation is presented. Different methods for connecting such different simulators are studied and classified.

### SUMMARY OF THE INVENTION

It is therefore an object of the application to ensure, in such a co-simulation in a simulation device for the outputting of image data, transmission of data between the simulations in which the two simulations exchange data as synchronously as possible.

In an exemplary embodiment, proposed is a simulation device for outputting image data from a virtual environment of a vehicle to a control unit, wherein the control unit is configured to perform at least one vehicle function dependent on the image data. The simulation device comprises an environment simulator which is configured to simulate the environment of the vehicle, and to transmit data about the environment to a sensor simulator which is configured to simulate at least one sensor of the vehicle for detecting the environment dependent on the data about the environment, and to output the image data dependent on its simulation. The environment simulator is designed to determine the data about the environment at simulation clock times and to transmit them to the sensor simulator dependent on the simulation clock times. The sensor simulator is designed to output the image data at sensor clock times, wherein information about the sensor clock times is stored in the environment simulator. The environment simulator is designed to transmit the data to the sensor simulator dependent on the sensor clock times.

Furthermore, it is provided to specify a test setup having such a simulation device and the control unit, which is testable dependent on the image data with regard to its vehicle function.

In addition, a method for outputting image data from a virtual environment of a vehicle to a control unit is provided, which, dependent on the image data, performs at least one vehicle function and is thus tested for this vehicle function, wherein the method is carried out on a simulation device, comprising the following method steps:

An environment simulator simulates the vehicle's environment and transmits the data about the environment to a sensor simulator.

The sensor simulator simulates at least one sensor of the vehicle for detecting the environment dependent on the data about the environment and outputs the image data dependent on this simulation, wherein the environment simulator determines the data about the environment at the simulation clock times and transmits them to the sensor simulator dependent on the simulation clock times, and wherein the sensor simulator outputs the image data at sensor clock times, wherein information about the sensor clock times is stored in the environment simulator, wherein the environment simulator transmits the data dependent on the sensor clock times to the sensor simulator.

A simulation device in the present case can be a device which is provided for a control unit in order to simulate for the control unit the environment that it would find in a vehicle and thus test the control unit for its functionality using this environment. For this purpose, the simulation device has computers that generate the data about the environment for the control unit and transmit them to the control unit, so that the control unit can be sufficiently tested in its functionality. This is particularly important for safety-relevant functions, but it is also necessary for other functions such as comfort functions in order to guarantee the user of the vehicle a function that is error-free. Because even a non-functioning comfort function can influence the driver in such a way that dangerous situations can occur. Such a simulation device is particularly important for electronic systems, because the most diverse states can be tested in order to test the function of the software and hardware on the control unit, as it would hardly be possible to do in a real test, for example. In addition, such a simulation device enables the drastic reduction of tests on the real vehicle, which can be both labor and thus cost intensive, as well as critical to safety.

The simulation device therefore outputs image data from a virtual environment of a vehicle to such a control unit so that this control unit performs its vehicle function dependent on these simulated image data, in order to first check whether the control unit interprets the image data correctly, and further to check whether the vehicle function is carried out correctly. The output of the image data by the sensor simulator at the sensor clock times may correspond to the output of the image data by the simulation device. In such an embodiment, the simulation device then also outputs the image data at the sensor clock times to the control unit.

The image data can already contain pre-processed data about the environment such as location of the tracked object, its motion vector, its speed and/or its acceleration, etc. Such preprocessing may be carried out in the sensor simulation or the simulation device may have, in embodiments, a preprocessing of the image data, wherein the preprocessing receives the image data output from the sensor simulation. It is also possible to transfer raw data output from the sensor simulation to the control unit, which are then first processed in the control unit and then used by the vehicle function.

The transmission of the image data to the control unit is also carried out by the simulation device as it would be carried out in the vehicle itself, in order to check the interfaces that the control unit has and the quality of the data transmission. The data can be transmitted, for example, via a bus, via point-to-point links or via wireless radio or optical transmission. The image data can be embedded in a specific format, i.e., in so-called data frames, which are also known as frames.

The simulation device can therefore be an electronic unit comprising interfaces that can be connected to the control unit and as shown above, has its own computing device, for example, a processor, to generate the image data.

The simulation device according to the application comprises an environment simulator which simulates the environment of the vehicle and transmits data about the environment to a sensor simulator which, dependent on this data about the environment, simulates at least one sensor of the vehicle for detecting the environment and then outputs the image data dependent on this simulation. This means that there is a first simulator, i.e., the environment simulator, which, according to the dependent claims, for example, has its own hardware or its own computer to simulate the vehicle environment. This simulation can be initiated by predetermined data, and then the data generated by this simulation is transmitted to the sensor simulator. The sensor simulator simulates the objects specified in this data in the environment of the vehicle for a sensor, which is usually an environment sensor capable of visually or acoustically tracking the objects covered by this data in the vehicle environment. Such environment sensors are, for example, radar, LIDAR, ultrasonic sensors and/or camera sensors.

This is a co-simulation, because the environment simulator simulates the vehicle environment with the objects in it, and the sensor simulator detects and/or tracks these objects with the provided environment sensor or sensors. Both simulators thus simulate the detection of such objects in the vehicle environment. In reality, the environment sensor then transmits the image data to the control unit. Since the sensor simulator also has its own computer, a data cable is usually provided between the environment simulator and the sensor simulator for transmitting the data. However, other means of transmission may also be provided. The transmission can be made optically, but also by radio or other known transmission methods.

Both the environment simulator and the sensor simulator can work with a predetermined clock period (hereinafter: clock). If both clocks differ in a way that none of the two clocks is an integer multiple of the other clock, which is sometimes the case, the decisive factor for the transmission of data from the environment simulator to the sensor simulator is when this transmission takes place. The two simulators, namely the environment simulator and the sensor simulator, should work as synchronously as possible. Since there is a different clock according to the definition above, it is provided that the environment simulator transmits its data at times that are determined dependent on the simulation clock times and the sensor clock times. For this purpose, the environment simulator has information about the sensor clock times and can thus determine the optimal transmission times itself. This ensures that the transmission of the data is as up to date as possible and that no outdated data from the vehicle environment is transmitted from the environment simulator to the sensor simulator.

This also applies to the corresponding method for outputting image data from a virtual environment of a vehicle to a control unit as well as for the test setup with the simulation device and the control unit.

The vehicle can be understood to be the one that has the environment sensors. This vehicle may be specifically referred to as an ego vehicle.

In general the term “ego vehicle” can represent a virtual vehicle in the center of a simulation or a test. E.g. the vehicle for that a new function is to be developed or tested. Typically, one skilled in the art uses such to distinguish a central vehicle (“ego”) from other vehicles or traffic participants (pedestrians, bicycles, etc.) that are usually called “fellows” or “fellow vehicles” that appear in a simulation or test and can interact or have an impact on the ego. For example, there may be several vehicles in a scenario in order to test a function of the ego vehicle but these fellow vehicles may not have the function to be tested, e.g. automatic braking systems.

The simulation clock is preferably smaller than the sensor clock, i.e., the environment simulator runs through shorter clock units, and these correspondingly more frequently. The storage of information about the sensor clock times refers to the storage of data from which said information can be read on a memory device assigned to the environment simulator. The simulation clock time is given after the completion of a recalculation of the vehicle environment. Accordingly, after completion of each simulation clock and thus at each simulation time, a complete description of the vehicle environment is available on the simulation computer, which depicts a snapshot of the vehicle environment. The sensor clock is defined independently of the simulation clock and defines the period between two sensor clock times for the outputting of image data. The sensor clock is normally selected in such a way that it simulates the sensor clock of a real sensor model for the simulation of which the sensor simulator is configured.

By the measures and further developments specified in the dependent claims, advantageous improvements to the simulation device specified in the independent claims or the method for outputting image data specified in the independent claims are possible.

It is provided, for example, that the environment simulator forms a difference between the simulation clock times and the sensor clock times in each case and transmits the data dependent on this difference. This allows for the environment simulator, for example, to determine the optimal time for the transmission itself.

This is achieved, for example, by the environment simulator comparing the difference to a threshold value and transmitting the data dependent on this comparison. For example, a threshold value can be a time, and the transmission can only take place if the difference is less than this threshold value. This always selects the optimal time to achieve synchronization between the environment simulator and the sensor simulator. It may be necessary to compare the difference to the threshold value after an amount formation. This means that the images that the environment simulator transmits to the sensor simulator through its data correspond to the current state of the vehicle environment, so that the sensor simulator performs its sensor simulation with the correct objects.

The data can be transmitted into frames. From communications engineering, it is a well-known concept that data can be transferred into frames, wherein the frame usually has a frame head, a range for payload data and an area for possible error correction. More or fewer areas in the frame can be defined. This is all optional, because it is also possible to only store the user data in frames.

The data about the environment may contain object data, wherein these object data contain in particular information about the respective locations of the respective objects. This makes it possible for the sensor simulation to capture the objects at a specific location via the sensor simulation and thus generate corresponding sensor data, which can then be sent to the control unit as image data, pre-processed or raw data. In addition to the locations, the image data can also have other object properties such as their extent, spatial orientation or shape. A motion vector can also be involved, for example.

Furthermore, it is provided that the sensor simulator and the environment simulator, as already stated above, can each have their own computer for carrying out their respective simulation, wherein in particular both the sensor simulator and the environment simulator are each designed as a separate assembly. This means that the sensor simulator and the environment simulator are independent of each other in terms of their simulation and have their own hardware to perform the calculations. The computer may have a processor and/or a microcontroller with one or more cores. It can also be a combination of a microprocessor and signal processors or similar. This also includes corresponding peripherals such as interfaces, memory, etc.

The environment simulator and the sensor simulator can be connected to a data cable for transmitting the data. This cable can be electrical or optical. It may optionally be designed coaxially, it may have several individual cables or, for example, several optical fibers.

The sensor simulator can delay the output at a sensor clock time if no new data about the environment has been transmitted by the environment simulation since the last output of image data. This allows the sensor simulator to wait for the latest environmental data in order to be able to output current image data.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a block diagram of a simulation device with a connected control unit,

FIG. 2 is a schematic representation of an ego vehicle with a plurality of sensor devices and objects in the environment,

FIG. 3 is a first flowchart of the method,

FIG. 4 is a second flowchart of the method,

FIG. 5 is a third flowchart of the method,

FIG. 6 is an exemplary data frame for transmitting the data, and

FIG. 7 is a table for determining the optimal time for transmitting the data.

### DETAILED DESCRIPTION

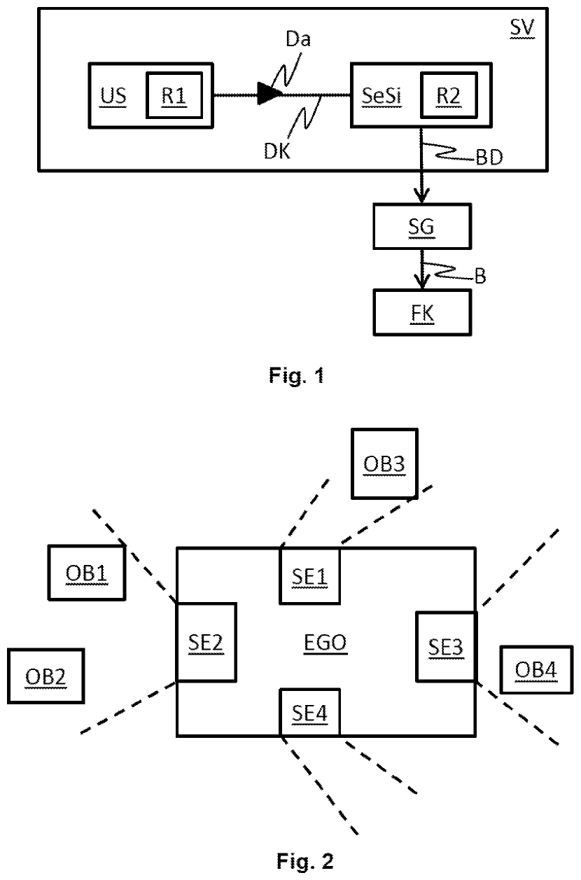

FIG. 1 shows a simulation device SV, which is connected to a control unit SG. The control unit SG is in turn connected to a vehicle component FK, to which the control unit SG sends a command B for the execution of a vehicle function (e.g., transmits a brake command). The simulation device SV comprises an environment simulator US comprising a first computer R1, wherein the computer R1 is configured to perform the environment simulation. For this purpose, the computer R1 has appropriate algorithms to carry out this environmental simulation, and can, for example, access initial data to run the environment simulation. The data Da, which is determined by the environment simulator US, is transmitted via the cable DK to the sensor simulator SeSi. The sensor simulator SeSi has a computer R2, which uses this data Da to perform a sensor simulation, for example, for a radar sensor, a camera sensor or a LIDAR sensor. The image data BD are then transmitted to the control unit SG, which is being tested. Based on the image data BD, the control unit SG determines whether the vehicle function is performed with the vehicle component FK or not. If necessary, the control unit SG also determines the extent to which the vehicle function is performed. For this purpose, a command B is transmitted to a vehicle component FK. This transmission can also take place, for example, via an in-vehicle communication network.

Since the environment simulator US simulates the environment with a different clock than the sensor simulator SeSi executes the sensor simulation, it is determined according to this application when the environment simulator US transmits the data Da to the sensor simulator SeSi. The prerequisite is that the synchronization of the two simulations is largely given. A deviation, which is specified, for example, by the solution according to the application, is considered sufficient synchronization. For example, the environment simulator US works with a clock of 1 ms and the sensor simulator SeSi with a clock of 30 ms, so that the environment simulator US should then perform the transmission with the correct time. The data transmission capacity of the data cable DK is also physically limited. The data Da is therefore not completely transmissible within a millisecond. Also, the processing of the data Da should only take place to the extent necessary. If more data Da has to be processed, for example, a more powerful computer R1 and corresponding peripherals are necessary. This is rarely technically and economically necessary. The clock of the sensor simulation SeSi can be an integer multiple of the simulation act of the environment simulation. In general, however, there will be no integer multiple. Then there can be significant deviations over several simulation cycles of the sensor simulator SeSi, so that the sensor simulator SeSi can no longer process the current data Da.

FIG. 2 shows the ego vehicle EGO with four environment sensors SE1 to SE4, which are shown by way of example. These environment sensors SE1 to SE4 can be radar, LIDAR, ultrasound or cameras or combinations thereof. The environment sensors SE1 to SE4 capture objects OB1 to OB4 in the environment of the ego vehicle EGO. In the example shown, the sensors SE1, SE2 and SE3 detect the respective objects OB3 and OB4 as well as the two objects OB1 and OB2. The crash sensor SE4 does not detect any object. These objects OB1 to OB4 are specified by the environment simulator US for the sensor simulator SeSi by means of the data Da.

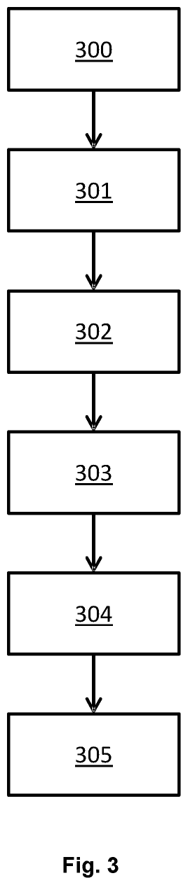

FIG. 3 shows in a first flowchart the method according to this application. In method step 300, the simulation of the environment of the ego vehicle EGO is carried out. In method step 301, the environment simulator US determines, dependent on the simulation clock times and the sensor clock times, when the data Da representing this environmental simulation should be transmitted to the sensor simulator SeSi. In method step 302, the transmission of the data Da takes place. In method step 303, the sensor simulator SeSi then uses this data Da for the sensor simulation. In method step 304, the image data BD are then generated by the simulated sensor simulation. In this case, pre-processing of the image data BD can already take place. In method step 305, the image data BD are then output from the simulation device SV to the control unit SG.

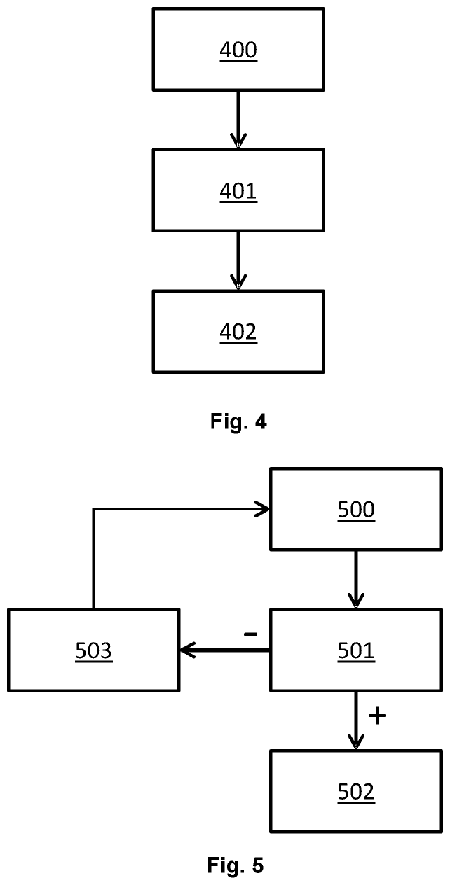

In FIG. 4, a second flowchart explains in more detail the determination of the time when the data Da is transmitted to the sensor simulator SeSi. In method step 400, the difference between the sensor time and the simulation time is formed. The sensor time depends on the sensor clock times and the simulation time on the simulation clock times. The sensor time is the time of transition from the respective current sensor simulation cycle to the subsequent simulation cycle. Accordingly, the simulation time is the time of transition from the respective current simulation cycle to the subsequent simulation cycle. With this difference, the time for the transmission is determined in method step 401. In method step 402, the transmission of the data Da then takes place as explained above.

In an example, FIG. 5 now explains this determination of the time for the transmission of the data Da according to FIG. 4 even more precisely. In method step 500, the difference between the sensor time and the simulation time is formed. This difference is compared in terms of amount in method step 501 with a threshold value. If the difference is less than this threshold value, the data Da is transmitted in method step 502. However, if the difference is greater than the threshold value, then the next simulation of the environment takes place in method step 503. The jump back to method step 500 then takes place and the method is run through again.

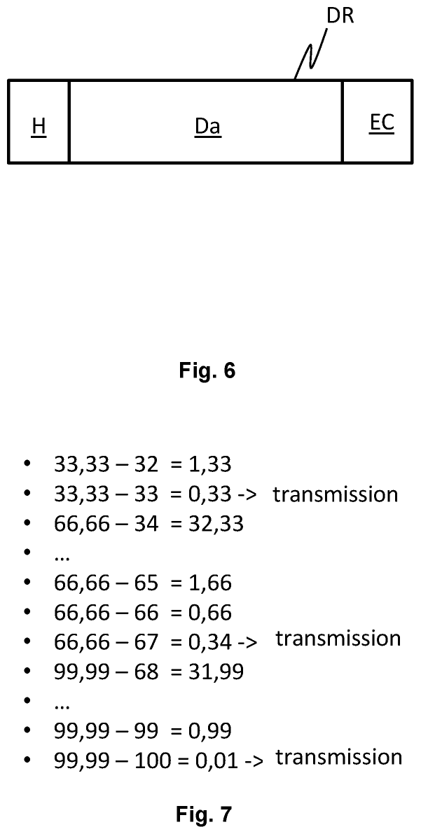

FIG. 6 shows an exemplary frame DR with which the data Da is transmitted from the environment simulator US to the sensor simulator SeSi. The data frame DR has a header H, which has, for example, a counter, followed by a range for the user data Da, i.e., the environment simulation, and finally a third area EC, which can be used, for example, for error correction.

FIG. 7 shows how the time for sending is determined using a concrete example via a table. The threshold is set here at 0.5 ms, the simulation time of the environment simulator US is 1 ms and the sensor time of the sensor simulator SeSi is 33.33 milliseconds (30 Hz).

At the beginning, therefore, in the first environment simulation, 1 ms is subtracted from 33.33 ms, leaving 32.33 ms as the difference. This difference is well above the threshold value of 0.5 ms, i.e., there is no transmission of the data Da. This is then repeated until arriving at the first line in FIG. 7, namely that now the 32nd simulation of the environment has taken place and thus a difference of 1.33 ms occurs. In the next step after the 33rd simulation, the difference is therefore only 0.33 ms, so that the threshold value is undercut and thus the data Da can be sent from the environment simulator US to the sensor simulator SeSi. The next sensor simulation is carried out, arriving at a cumulative sensor time of 66.66 ms. With the next environmental simulation, however, a value of 34 ms for the cumulative simulation time is obtained, so that then the difference is 32.33 ms. This is then repeated millisecond by millisecond until arriving at the 65th sensor simulation, which then leads to a difference of 1.66 ms in the fourth row of the table. The next simulation in the following line results in a difference of 0.66 ms, which is still above the threshold value of 0.5 ms. In the following line, however, a difference of −0.34 ms is obtained. This means that the amount of the difference is below the threshold so that the data Da can be sent as a result. This leads to the next sensor simulation, so that in the next line the sensor simulation jumps to the value 99.99 ms. After sending the data Da, however, the environment simulation is the 68th, so the difference is 31.99 ms. For sake of simplicity, it is skipped to the 99th environment simulation. The difference is now 0.99 ms. The difference is therefore still above the threshold value of 0.5 ms.

After the 100th environment simulation, there is then a difference of −0.01 ms, i.e., 0.01 ms in terms of amount, so that the data Da can now be sent again. This example teaches that in order to determine the optimal synchronization time, the difference must be obtained. Here, the environment simulator US delays sending the data Da to the sensor simulator SeSi from the sensor clock time 99.99 to the time 100, i.e., the time of the next simulation clock, in order to ensure that the next sensor clock can be executed with the current data Da.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A simulation device to output image data from a virtual environment of a vehicle to a control unit, which is designed to perform at least one vehicle function dependent on the image data, the simulation device comprising:
an environment simulator designed to simulate the environment of the vehicle and to transmit data about an environment to a sensor simulator, which is configured to simulate at least one sensor of the vehicle for detecting the environment dependent on the data about the environment and to output the image data dependent on the simulation,
wherein the environment simulator determines the data about the environment at simulation clock times and to transmit these to the sensor simulator dependent on the simulation clock times,
wherein the sensor simulator is configured to output the image data at sensor clock times,
wherein information about the sensor clock times is stored in the environment simulator, and
wherein the environment simulator is configured to transmit the data to the sensor simulator dependent on the sensor clock times.

2. The simulation device according to claim 1, wherein the environment simulator is configured to form a difference between simulation clock times and sensor clock times and to transmit the data dependent on this difference.

3. The simulation device according to claim 2, wherein the environment simulator is configured to compare the difference to a threshold value and to transmit the data dependent on this comparison.

4. The simulation device according to claim 1, wherein the environment simulator is configured to transmit the data into data frames.

5. The simulation device according to claim 1, wherein the data have information about objects in the environment, and wherein the data have information about the respective locations of the objects.

6. The simulation device according to claim 1, wherein the sensor simulator and the environment simulator each have a respective computer for executing their respective simulation.

7. The simulation device according to claim 1, wherein a data cable for transmitting the data is provided between the environment simulator and the sensor simulator.

8. A test setup comprising a simulation device according to claim 1 and comprising a control unit that is adapted to be tested with regard to its vehicle function dependent on the image data.

9. A method for outputting image data from a virtual environment of a vehicle to a control unit, which performs at least one vehicle function dependent on the image data and is thus tested for this vehicle function, the method being executable on a simulation device, the method comprising:
simulating via an environment simulator the environment of the vehicle; and
transmitting data about an environment to a sensor simulator, the sensor simulator simulating at least one sensor of the vehicle for capturing the environment dependent on the data about the environment and outputting the image data dependent on this simulation;
determining, via the environment simulator, the data about the environment at simulation clock times and transmits these to the sensor simulator dependent on the simulation clock times; and
outputting, via the sensor simulator, the image data at sensor clock times,
wherein information about the sensor clock times is stored in the environment simulator, and
wherein the environment simulator transmits the data dependent on the sensor clock times to the sensor simulator.

10. The method according to claim 9, wherein the environment simulator forms a difference between simulation clock times and sensor clock times and transmits the data dependent on this difference.

11. The method according to claim 10, wherein the environment simulator compares the difference to a threshold value and transmits the data dependent on this comparison.

12. The method according to claim 9, wherein the environment simulator transmits the data into frames.

13. The method according to claim 9, wherein the sensor simulator delays the output at a sensor clock time if no new data about the environment have been transmitted by the environment simulation since the last outputting of image data.
